(19) United States
(12) Patent Application Publication
(10) Pub. No.: US 2026/0247409 A1
(43) Pub. Date: Aug. 20, 2026

(54) STARTING OR RESTARTING METHOD FOR SIDELINK CGT, AND COMMUNICATION APPARATUS

(71) Applicant: BEIJING XIAOMI MOBILE SOFTWARE CO., LTD., Beijing (CN)

(72) Inventor: Xiaowei JIANG, Beijing (CN)

(73) Assignee: BEIJING XIAOMI MOBILE SOFTWARE CO., LTD., Beijing (CN)

(21) Appl. No.: 19/156,041

(22) PCT Filed: Feb. 15, 2023
(86) PCT No.: PCT/CN2023/076296

§ 371 Date: Aug. 13, 2025

(51) Int. Cl. H04W 72/25; H04L 1/1867; H04L 5/00

(52) U.S. Cl. CPC H04W 72/25; H04L 1/1896; H04L 5/0055

(57) ABSTRACT

A method for starting or restarting a sidelink (SL) configured grant timer (CGT). The method includes receiving downlink control information (DCI) sent by a network device; and starting or restarting a sidelink CGT associated with a sidelink hybrid automatic repeat request (HARQ) process according to sidelink transmission scheduled by the DCI.

### CROSS REFERENCE TO RELATED APPLICATION

The present application is a U.S. National Stage of International Application No. PCT/CN2023/076296, filed on Feb. 15, 2023, the entire contents of which are incorporated herein by reference.

### BACKGROUND OF THE INVENTION

In the related art, a network device may control automatic transmission of a terminal by configuring a configured grant timer (CGT) for the terminal. In order to support direct communication between terminals, a sidelink communication manner is introduced. How to support the CGT is an urgent problem to be solved in sidelink communication.

### SUMMARY OF THE INVENTION

An embodiment of a first aspect of the present disclosure provides a method for starting or restarting a sidelink (SL) CGT, including:
receiving downlink control information (DCI) sent by a network device; and
starting or restarting a sidelink CGT associated with a sidelink hybrid automatic repeat request (HARQ) process according to the sidelink transmission scheduled by the DCI.

An embodiment of a second aspect of the present disclosure provides a method for starting or restarting a sidelink CGT, including:
sending DCI to a terminal, where the DCI is configured to start or restart a sidelink CGT associated with a sidelink HARQ process according to the sidelink transmission scheduled by the DCI.

An embodiment of a third aspect of the present disclosure provides a communication device, including a processor and a memory, where a computer program is stored in the memory, and the processor executes the computer program stored in the memory to enable the device to:
receive DCI sent by a network device; and
start or restart a sidelink CGT associated with a sidelink HARQ process according to the sidelink transmission scheduled by the DCI.

An embodiment of a fourth aspect of the present disclosure provides a non-transitory computer-readable storage medium, configured to store instructions, where the instructions, when executed, cause the method described in the first aspect above to be implemented.

An embodiment of a fifth aspect of the present disclosure provides a communication device, comprising a processor and a memory, where a computer program is stored in the memory, and the processor executes the computer program stored in the memory to enable the device to perform the method described in the second aspect above.

An embodiment of a sixth aspect of the present disclosure provides a non-transitory computer-readable storage medium, configured to store instructions, where the instructions, when executed, cause the method described in the second aspect above to be implemented.

### BRIEF DESCRIPTION OF DRAWINGS

In order to more clearly illustrate technical solutions in the embodiments of the present disclosure or the background, accompanying drawings that need to be used in the embodiments of the present disclosure or the background are described below.

FIG. 1 is a schematic diagram of an architecture of a communication system provided by an embodiment of the present disclosure.

FIG. 2 is a schematic diagram of interaction among a network device, a sending terminal, and a receiving terminal provided by an embodiment of the present disclosure.

FIG. 3 is a schematic flowchart of a method for starting or restarting a sidelink CGT provided by an embodiment of the present disclosure.

FIG. 4 is a schematic flowchart of a method for starting or restarting a sidelink CGT provided by another embodiment of the present disclosure.

FIG. 5 is a schematic flowchart of a method for starting or restarting a sidelink CGT provided by another embodiment of the present disclosure.

FIG. 6 is a schematic flowchart of a method for starting or restarting a sidelink CGT provided by another embodiment of the present disclosure.

FIG. 7 is a schematic flowchart of a method for starting or restarting a sidelink CGT provided by another embodiment of the present disclosure.

FIG. 8 is a schematic flowchart of a method for starting or restarting a sidelink CGT provided by another embodiment of the present disclosure.

FIG. 9 is a schematic diagram of a structure of a communication device provided by an embodiment of the present disclosure.

FIG. 10 is a schematic diagram of a structure of a communication device provided by another embodiment of the present disclosure.

FIG. 11 is a schematic diagram of a structure of a chip provided by an embodiment of the present disclosure.

### DETAILED DESCRIPTION OF THE INVENTION

In order to better understand a method for starting or restarting a sidelink CGT disclosed by an embodiment of the present disclosure, a communication system to which the embodiment of the present disclosure is applicable is first described below.

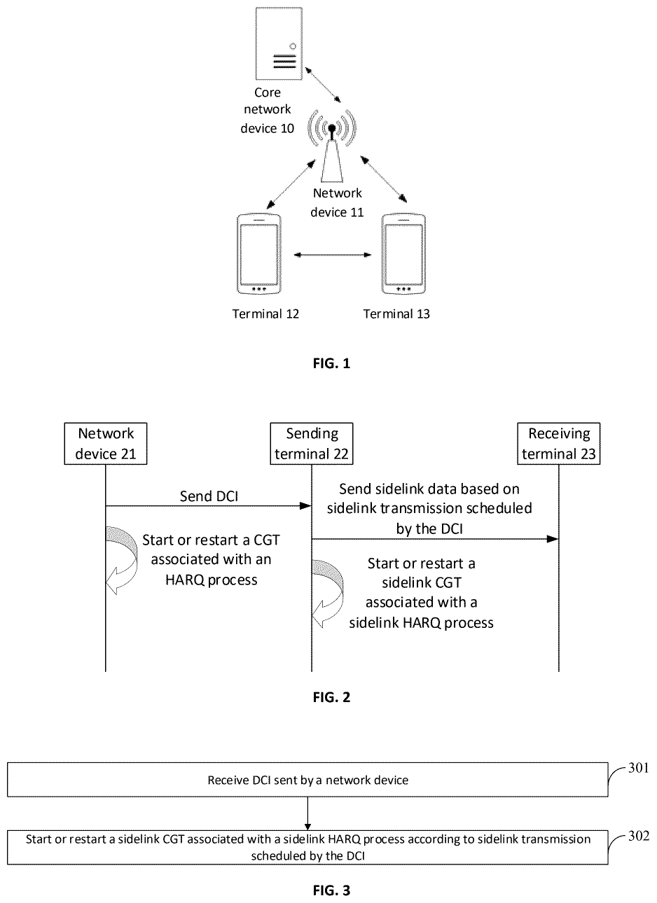

Please refer to FIG. 1. FIG. 1 is a schematic diagram of an architecture of a communication system provided by an embodiment of the present disclosure. The communication system may include, but is not limited to, a network device and two terminals. The terminals are connected with each other via a sidelink. The numbers and forms of the devices shown in FIG. 1 are merely for example and do not constitute a limitation of the embodiment of the present disclosure. Two or more network devices and two or more terminals may be included in a practical application. The communication system shown in FIG. 1 takes an example of including one network device 11 and two terminals 12 and 13. The terminal 12 and the terminal 13 are connected to each other via the sidelink.

In the present disclosure, the terminal 12 may be a sending terminal, and the terminal 13 may be a receiving terminal. There may be one or more terminals 13, which are not limited in the present disclosure. Or, the terminal 13 may be a sending terminal, and the terminal 12 may be a receiving terminal. There may be one or more terminals 12, which are not limited in the present disclosure.

It is to be noted that the technical solution of the embodiment of the present disclosure may be applied to various communication systems, such as a long term evolution (LTE) system, a 5th generation (5G) mobile communication system, a 5G new radio (NR) system, or other future new type mobile communication systems. It is further to be noted that the sidelink in the embodiment of the present disclosure may further be referred to as a side link or a direct link.

The network device 11 in the embodiment of the present disclosure is an entity on a network side, which is configured to transmit or receive a signal. FIG. 1 further shows a core network device 10 communicating with the entity. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system, etc. The specific technology and specific device form adopted for the network device are not limited in the embodiment of the present disclosure. The network device provided by the embodiment of the present disclosure may include a central unit (CU) and a distributed unit (DU). The CU may also be referred to as a control unit. By adopting a CU-DU structure, protocol layers of the network device, e.g., the base station, may be divided. Functions of part of the protocol layers are placed in the CU for central control. Functions of part or all of the rest of the protocol layers are distributed in the DUs, and the DUs are centrally controlled by the CU.

The terminal in the embodiment of the present disclosure is an entity on a user side, such as a mobile phone, which is configured to receive or transmit a signal. The terminal may also be referred to as a terminal, user equipment (UE), a mobile station (MS), a mobile terminal (MT), etc. The terminal may be a car with a communication function, a smart car, a mobile phone, a wearable device, a pad, a computer with a wireless receiving and sending function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. The specific technology and specific device form adopted for the terminal are not limited by the embodiment of the present disclosure.

It may be understood that the communication system described in the embodiment of the present disclosure is to more clearly illustrate the technical solution of the embodiment of the present disclosure, and does not constitute a limitation on the technical solution provided by the embodiment of the present disclosure. It may be known to those ordinarily skilled in the art that with the evolution of a system architecture and the emergence of new service scenarios, the technical solution provided by the embodiment of the present disclosure is also applicable to similar technical problems.

In the related art, a network device may control the automatic transmission of a terminal by configuring a CGT to the terminal. In order to support direct communication between the terminals, a sidelink communication manner is introduced. How to support the CGT is an urgent problem to be solved in sidelink communication.

In the present disclosure, the terminal may receive DCI sent by the network device, and start or restart an SL CGT associated with a sidelink HARQ process according to the sidelink transmission scheduled by the DCI. Thus, the terminal may control the starting or restarting of the sidelink CGT associated with the sidelink HARQ process based on the sidelink transmission scheduled by the DCI.

A method for starting or restarting a sidelink CGT, and a communication device provided by the present disclosure are introduced in detail below in conjunction with the accompanying drawings.

Firstly, it is stated that the sidelink communication may have the following two allocation manners of sending resources. In one manner, sending resources are scheduled by the network (which may be called mode 1), and in the other manner, the sending resources are autonomously selected (which may be called mode 2). The allocation manner that is specifically used by the terminal may be configured by the network device via radio resource control (RRC) signaling. A terminal running in mode 1 may send sidelink data through a dynamic sidelink grant scheduled by the network, or may also send the sidelink data through a configured sidelink grant configured by the network.

FIG. 2 is a schematic diagram of interaction among a network device 21, a sending terminal 22, and a receiving terminal 23 provided by an embodiment of the present disclosure.

As shown in FIG. 2, the network device 21 may send DCI to the sending terminal 22, and may start or restart a CGT associated with an HARQ process. The sending terminal 22 may receive the DCI sent by the network device 21, send sidelink data to the receiving terminal 23 based on sidelink transmission scheduled by the DCI, and start or restart a sidelink CGT associated with a sidelink HARQ process.

Please refer to FIG. 3. FIG. 3 is a schematic flowchart of a method for starting or restarting a sidelink CGT provided by an embodiment of the present disclosure. The method is performed by a terminal, and the terminal may be a sending terminal. As shown in FIG. 3, the method may include, but is not limited to, the following steps 301 and 302.
In step 301, the DCI sent by a network device is received.

In the present disclosure, the terminal may send sidelink data through a dynamic sidelink grant scheduled by the network device. The dynamic sidelink grant may be scheduled through the DCI. The terminal may receive the DCI sent by the network device. Three transmission resources may be indicated in the DCI. Each transmission resource includes a physical sidelink control channel (PSCCH) and a physical sidelink shared channel (PSSCH).

If a new data indicator (NDI) carried by the DCI is toggled compared to the last scheduling, it means that the type of sidelink transmission scheduled by the DCI is initial transmission, and the three transmission resources are one initial transmission resource and two retransmission resources. If the NDI is not toggled compared to the last scheduling, it means that the type of the sidelink transmission scheduled by the DCI is retransmission, and the three transmission resources are all retransmission resources.
In step 302, a sidelink CGT associated with a sidelink HARQ process is started or restarted according to the sidelink transmission scheduled by the DCI.

In the present disclosure, the sidelink CGT may be maintained by the sidelink HARQ process.

In the present disclosure, the terminal may start or restart the sidelink CGT associated with the sidelink HARQ process when receiving the initial transmission resource or the retransmission resource scheduled by the DCI, or may start or restart the sidelink CGT associated with the sidelink HARQ process according to the PSSCH in the sidelink transmission scheduled by the DCI.

In the embodiment of the present disclosure, the terminal may receive the DCI sent by the network device, and start or restart the sidelink CGT associated with the sidelink HARQ process according to the sidelink transmission scheduled by the DCI. Thus, the terminal may control starting or restarting of the sidelink CGT associated with the sidelink HARQ process based on the sidelink transmission scheduled by the DCI.

Please refer to FIG. 4. FIG. 4 is a schematic flowchart of a method for starting or restarting a sidelink CGT provided by another embodiment of the present disclosure. The method is performed by the terminal, and the terminal may be the sending terminal. As shown in FIG. 4, the method may include, but is not limited to, the following steps 401 to 403.
In step 401, the DCI sent by the network device is received.

In the present disclosure, step 401 may adopt any implementation in various embodiments of the present disclosure, respectively, which is not limited by the present disclosure and will not be repeated.
In step 402, according to an HARQ process identifier carried by the DCI, a sidelink HARQ process associated with the HARQ process identifier is determined.

In the present disclosure, the terminal may determine the sidelink HARQ process associated with the HARQ process identifier carried by the DCI according to an association relationship between the HARQ process identifier and the sidelink HARQ process.
In step 403, the sidelink CGT associated with the sidelink HARQ process is started or restarted.

In the present disclosure, the terminal may start or restart the sidelink CGT associated with the sidelink HARQ process.

In some examples, the terminal may determine whether to perform initial transmission or retransmission according to the NDI carried by the DCI. If the NDI is toggled compared to the last scheduling, it means that the type of sidelink transmission scheduled by the DCI is the initial transmission. If the NDI is not toggled compared to the last scheduling, it means that the type of the sidelink transmission scheduled by the DCI is the retransmission. Regardless of whether the type of the sidelink transmission scheduled by the DCI is the initial transmission or the retransmission, the terminal determines the sidelink HARQ process associated with the HARQ process identifier carried by the DCI, and starts or restarts the sidelink CGT associated with the sidelink HARQ process.

In the embodiment of the present disclosure, the terminal may receive the DCI sent by the network device, determine the sidelink HARQ process associated with the HARQ process identifier based on the HARQ process identifier carried by the DCI, and start or restart the sidelink CGT associated with the sidelink HARQ process. Thus, the terminal may implement automatic transmission on the sidelink HARQ process through the sidelink CGT based on the starting or restarting of the sidelink CGT associated with the sidelink HARQ process.

Please refer to FIG. 5. FIG. 5 is a schematic flowchart of a method for starting or restarting a sidelink CGT provided by another embodiment of the present disclosure. The method is performed by the terminal, and the terminal may be the sending terminal. As shown in FIG. 5, the method may include, but is not limited to, the following steps 501 and 502.
In step 501, the DCI sent by the network device is received.

In the present disclosure, step 501 may adopt any implementation in various embodiments of the present disclosure, respectively, which is not limited by the present disclosure and will not be repeated.
In step 502, the sidelink CGT associated with the sidelink HARQ process is started or restarted according to a PSSCH in the sidelink transmission.

In the present disclosure, the sidelink transmission scheduled by the DCI may include three transmission resources. Each transmission resource may be used for one transmission, and thus the three transmission resources may be used for three transmissions. Each transmission resource includes a PSCCH and a PSSCH.

In some examples, the terminal may start or restart the sidelink CGT associated with the sidelink HARQ process at the end of each PSSCH transmission in the sidelink transmission. The end of each PSSCH transmission may be understood as the end of transmission using the PSSCH in each of the three transmission resources. The end of the PSSCH transmission may mean that no LBT failure indication is received from a physical layer.

For example, the sending terminal may start or restart the sidelink CGT associated with the sidelink HARQ process at the first slot or the first symbol at the end of each PSSCH transmission. For example, the sending terminal may start or restart the sidelink CGT associated with the sidelink HARQ process at the first slot or the first symbol at the start of each PSSCH transmission.

In some examples, the terminal may start or restart the sidelink CGT associated with the sidelink HARQ process at the end of the last PSSCH transmission in the sidelink transmission. The end of the last PSSCH transmission may be the end of transmission using the PSSCH in the last of the three transmission resources.

For example, the sending terminal may start or restart the sidelink CGT associated with the sidelink HARQ process at the first slot or the first symbol at the end of the last PSSCH transmission. For example, the sending terminal may start or restart the sidelink CGT associated with the sidelink HARQ process at the first slot or the first symbol at the start of the last PSSCH transmission.

In some examples, the terminal may also send sidelink data according to a configured sidelink grant configured by the network device. For one sidelink HARQ process, three transmission resources are included in one configured sidelink grant cycle. The three transmission resources are one initial transmission resource and two retransmission resources. Each transmission resource includes a PSCCH and a PSSCH. The terminal may start or restart the sidelink CGT associated with the sidelink HARQ process at the first slot or the first symbol at the end of each PSSCH transmission, or may also start or restart the sidelink CGT associated with the sidelink HARQ process at the first slot or the first symbol at the end of the last PSSCH transmission.

In the embodiment of the present disclosure, the terminal may receive the DCI sent by the network device, and start or restart the sidelink CGT associated with the sidelink HARQ process based on the PSSCH in the sidelink transmission scheduled by the DCI. Thus, the terminal may control starting or restarting of the sidelink CGT associated with the sidelink HARQ process based on the PSSCH in the sidelink transmission, and implement automatic transmission on the sidelink HARQ process through the sidelink CGT.

Please refer to FIG. 6. FIG. 6 is a schematic flowchart of a method for starting or restarting a sidelink CGT provided by another embodiment of the present disclosure. The method is performed by the terminal, and the terminal may be the sending terminal. As shown in FIG. 6, the method may include, but is not limited to, the following steps 601 and 602.
In step 601, the DCI sent by the network device is received.

In the present disclosure, step 601 may adopt any implementation in various embodiments of the present disclosure, respectively, which is not limited by the present disclosure and will not be repeated.
In step 602, it is determined whether to stop the sidelink CGT associated with the sidelink HARQ process according to HARQ feedback associated with the PSSCH in the sidelink transmission.

In the present disclosure, the HARQ feedback associated with the PSSCH may be understood as HARQ feedback on a physical sidelink feedback channel (PSFCH) associated with the PSSCH. The sidelink HARQ process is an HARQ process associated with the PSSCH.

In the present disclosure, HARQ feedback modes for multicast transmission may include a positive-negative acknowledgement (ACK-NACK) and a negative-only acknowledgement (NACK-only). The ACK-NACK mode means that the HARQ feedback may carry both an ACK and an NACK. The NACK-only mode means that the HARQ feedback may only carry an NACK.

In the present disclosure, in a case where a service type is a multicast service and the HARQ feedback mode is the ACK-NACK, it means that PSSCH transmission is successful if an ACK for an HARQ-enabled data packet is detected on the PSFCH associated with the PSSCH, and the sidelink CGT associated with the sidelink HARQ process may be stopped if the sidelink CGT associated with the sidelink HARQ process is running.

In some examples, in the three transmission resources in the sidelink transmission scheduled by the DCI, the sidelink CGT associated with the sidelink HARQ process may be stopped if the ACK is detected on the PSFCH associated with the PSSCH in a current transmission resource and the sidelink CGT associated with the sidelink HARQ process is running. For example, in the three transmission resources, retransmission may be performed using the second transmission resource if the NACK is detected on the PSFCH associated with the PSSCH in the first transmission resource. The sidelink CGT associated with the sidelink HARQ process may be stopped if the ACK is detected on the PSFCH associated with the PSSCH in the second transmission resource and the sidelink CGT associated with the sidelink HARQ process is running.

In the case where the service type is the multicast service and the HARQ feedback mode is the ACK-NACK, it may be considered that the PSSCH transmission is not successful if an NACK for the HARQ-enabled data packet is detected on the PSFCH associated with the PSSCH, and the sidelink CGT associated with the sidelink HARQ process may not be stopped if the sidelink CGT associated with the sidelink HARQ process is running. In some examples, the terminal may restart the sidelink CGT associated with the sidelink HARQ process. Detecting the NACK on the PSFCH associated with the PSSCH may mean that the NACK is received on the PSFCH or that no HARQ feedback is detected on the PSFCH.

In a case where the service type is the multicast service and the HARQ feedback mode is the NACK-only, it may be considered that the PSSCH transmission is successful if no HARQ feedback for the HARQ-enabled data packet is detected on the PSFCH associated with the PSSCH, and the sidelink CGT associated with the sidelink HARQ process may be stopped if the sidelink CGT associated with the sidelink HARQ process is running.

In a case where the service type is a unicast service, it means that the PSSCH transmission is successful if the ACK for the HARQ-enabled data packet is detected on the PSFCH associated with the PSSCH, and the sidelink CGT associated with the sidelink HARQ process may be stopped if the sidelink CGT associated with the sidelink HARQ process is running.

In the case where the service type is the unicast service, it means that the PSSCH transmission is not successful if the NACK for the HARQ-enabled data packet is detected on the PSFCH associated with the PSSCH. The sidelink CGT associated with the sidelink HARQ process may not be stopped if the sidelink CGT associated with the sidelink HARQ process is running.

In some examples, for an HARQ-disenabled data packet, the terminal may determine when to stop the sidelink CGT associated with the sidelink HARQ process according to implementation if the sidelink CGT associated with the sidelink HARQ process is running. In a possible implementation, the terminal may determine not to perform the next retransmission according to the implementation, and the terminal may stop the sidelink CGT associated with the sidelink HARQ process if the sidelink CGT associated with the sidelink HARQ process is running.

In some examples, the terminal may also send sidelink data according to a configured sidelink grant configured by the network device. For one sidelink HARQ process, three transmission resources are included in one configured sidelink grant cycle. The three transmission resources are one initial transmission resource and two retransmission resources. Each transmission resource includes a PSCCH and a PSSCH. The terminal may determine whether to stop the sidelink CGT associated with the sidelink HARQ process according to the HARQ feedback associated with the PSSCH in the transmission resource of the configured sidelink grant. A detailed process is the same as that in the case of DCI scheduling above, and thus will not be repeated here.

In the embodiment of the present disclosure, the terminal may receive the DCI sent by the network device, and determine whether to stop the sidelink CGT associated with the sidelink HARQ process according to the HARQ feedback associated with the PSSCH in the sidelink transmission. Thus, the terminal may control the running of the sidelink CGT associated with the sidelink HARQ process based on the HARQ feedback associated with the PSSCH.

In an embodiment of the present disclosure, the terminal may start or restart the sidelink CGT associated with the sidelink HARQ process at the end of the physical uplink control channel (PUCCH) transmission for transmitting the HARQ feedback associated with the sidelink transmission. The HARQ feedback may be the NACK.

In some examples, if a time Alignment Timer (TAT) associated with a timing advance group (TAG), where a serving cell, which carries the HARQ feedback and is configured with the PUCCH (i.e., a serving cell where a PUCCH resource transmitting the HARQ feedback is located), is located, does not time out, the terminal needs to send the HARQ feedback on the PUCCH. The terminal may start or restart the sidelink CGT associated with the sidelink HARQ process at the end of the PUCCH transmission if the NACK is carried on the PUCCH.

In some examples, the sending terminal may start or restart the sidelink CGT associated with the sidelink HARQ process at the first slot or the first symbol at the end of the PUCCH transmission.

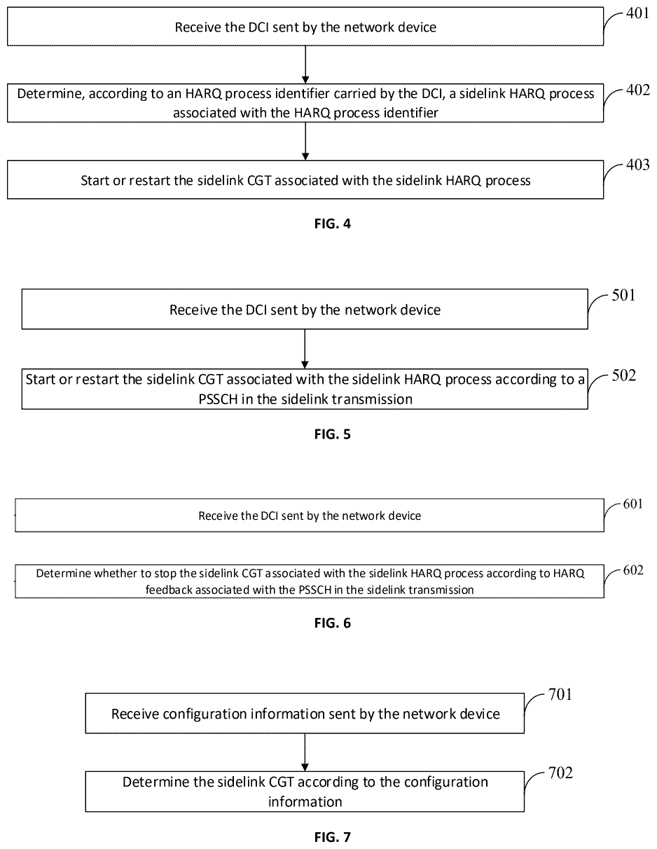

Please refer to FIG. 7. FIG. 7 is a schematic flowchart of a method for starting or restarting a sidelink CGT provided by another embodiment of the present disclosure. The method is performed by the terminal. As shown in FIG. 7, the method may further include, but is not limited to, the following steps 701 and 702.
In step 701, configuration information sent by the network device is received.

In the present disclosure, the configuration information received by the terminal from the network device may include any one of: a sidelink CGT corresponding to the terminal; a sidelink CGT corresponding to a configured sidelink grant configuration; a sidelink CGT corresponding to a resource pool; a sidelink CGT corresponding to a bandwidth part (BWP); or a sidelink CGT corresponding to a resource block set.
In step 702, the sidelink CGT is determined according to the configuration information.

In the present disclosure, the sidelink CGT may be determined based on the configuration information sent by the network device. The sidelink CGT may be maintained by a sidelink HARQ process.

In the present disclosure, the sidelink CGT may be configured at a granularity of the terminal, at a granularity of the configured sidelink grant configuration, at a granularity of the resource pool, at a granularity of the BWP, or at a granularity of the resource block set.

In the present disclosure, the sidelink CGT may be configured by the network device, or may be pre-configured, which is not limited in the present disclosure.

In some examples, a terminal in an RRC connected state may obtain sidelink CGT configuration through dedicated signaling. A terminal in an RRC IDLE/INACTIVE state may obtain the sidelink CGT configuration through a system information block (SIB). A terminal that is not in the network coverage may obtain the sidelink CGT configuration through pre-configuration.

In the embodiment of the present disclosure, the terminal may receive the configuration information sent by the network device, and determine the sidelink CGT according to the configuration information, such that the sidelink CGT may be supported in a case where automatic retransmission on the configured sidelink grant is supported in sidelink communication.

Please refer to FIG. 8. FIG. 8 is a schematic flowchart of a method for starting or restarting a sidelink CGT provided by another embodiment of the present disclosure. The method is performed by a network device. As shown in FIG. 8, the method may include, but is not limited to, the following step 801.
In step 801, DCI is sent to a terminal. The DCI is configured to start or restart a sidelink CGT associated with a sidelink HARQ process according to sidelink transmission scheduled by the DCI.

In the present disclosure, the network device may schedule a dynamic sidelink grant to the terminal, such that the terminal may send sidelink data through the dynamic sidelink grant scheduled by the network device. The dynamic sidelink grant may be scheduled through the DCI, i.e., the network device may send the DCI to the terminal so as to schedule the dynamic sidelink grant to the terminal. Three transmission resources may be indicated in the DCI. Each transmission resource includes a PSCCH and a PSSCH. After receiving the DCI, the terminal may start or restart the sidelink CGT associated with the sidelink HARQ process according to the sidelink transmission scheduled by the DCI.

In the embodiment of the present disclosure, the network device may send the DCI to the terminal. The DCI is configured to start or restart the sidelink CGT associated with the sidelink HARQ process according to the sidelink transmission scheduled by the DCI. Thus, the terminal may control starting or restarting of the sidelink CGT associated with the sidelink HARQ process based on the sidelink transmission scheduled by the DCI.

In order to facilitate understanding of the method for starting or restarting the sidelink CGT of the present disclosure, an illustration is made below in conjunction with the following embodiments.

In an embodiment, the sidelink configured grant timer is supported.

In some examples, one sidelink configured grant timer is defined. The timer may be configured per UE/per CG configuration/per resource pool/per BWP/per resource block set (RB set). A terminal in an RRC connected state may obtain the configuration of the sidelink configured grant timer through dedicated signaling. A terminal in an RRC IDLE/INACTIVE state may obtain the configuration of the sidelink configured grant timer through an SIB. A terminal out of coverage (OOC) may obtain the configuration of the sidelink configured grant timer through pre-configuration. The sidelink configured grant timer may be maintained by the sidelink HARQ process.

In an embodiment, the sending terminal receives initial transmission or retransmission scheduled by the DCI, and starts or restarts the sidelink configured grant timer associated with the sidelink HARQ process.

In some examples, the terminal determines whether to perform initial transmission or retransmission according to the HARQ process ID and ND carried in the DCI. The terminal determines the sidelink HARQ process associated with the HARQ process ID, and starts or restarts the sidelink configured grant timer associated with the sidelink HARQ process.

In an embodiment, the sending terminal starts or restarts the sidelink configured grant timer associated with the sidelink HARQ process every time a sending of the PSSCH is completed.

In some examples, the sending terminal starts or restarts the sidelink configured grant timer associated with the sidelink HARQ process at the end of each PSSCH sending. The end of the PSSCH sending means that PSSCH transmission is successful, and no LBT failure indication is received from a physical layer. For example, the sending terminal may start or restart the sidelink configured grant timer associated with the sidelink HARQ process at the first slot/symbol at the end of the PSSCH transmission. For example, the sending terminal may start or restart the sidelink configured grant timer associated with the sidelink HARQ process at the first slot/symbol at the start of the PSSCH transmission.

In some examples, the terminal judges whether to stop the sidelink configured grant timer associated with the sidelink HARQ process according to the HARQ feedback associated with the PSSCH.

In some examples, for an ACK-NACK feedback mode of a multicast, for an HARQ enabled media access control protocol data unit (MAC PDU), if the sending terminal detects an ACK on a PSFCH resource associated with a configured sidelink grant (a configured sidelink grant for transmitting the PSSCH), the sending terminal stops the sidelink configured timer associated with the sidelink HARQ process (a sidelink HARQ process associated with the PSSCH) (if the sidelink configured timer associated with the sidelink HARQ process is running). If the sending terminal detects an NACK on the PSFCH resource associated with the configured sidelink grant (the configured sidelink grant for transmitting the PSSCH) (the NACK is received on the PSFCH or no HARQ feedback is detected on the PSFCH), the sending terminal does not stop the sidelink configured timer associated with the sidelink HARQ process (the sidelink HARQ process associated with the PSSCH). In some examples, the terminal may restart the sidelink configured timer associated with the sidelink HARQ process. For an NACK-only mode of the multicast, for the HARQ-enabled MAC PDU, if no HARQ feedback is detected on the PSFCH, the sending terminal stops the sidelink configured timer associated with the sidelink HARQ process (the sidelink HARQ process associated with the PSSCH) (if the sidelink configured timer associated with the sidelink HARQ process is running).

In some examples, for an HARQ-disenabled MAC PDU, before the sidelink configured grant timer associated with the sidelink HARQ process times out, the terminal determines, according to implementation, when to stop the sidelink configured grant timer associated with the sidelink HARQ process (if the sidelink configured grant timer associated with the sidelink HARQ process is running). In a possible implementation, the terminal determines not to perform the next retransmission according to the implementation. The terminal stops the sidelink configured grant timer associated with the sidelink HARQ process (if the sidelink configured grant timer associated with the sidelink HARQ process is running).

In an embodiment, the sending terminal does not start or restart the sidelink configured grant timer associated with the sidelink HARQ process until sending of the last PSSCH is completed.

In some examples, the sending terminal does not start or restart the sidelink configured grant timer associated with the sidelink HARQ process until the last PSSCH sending is completed (here, it refers to the last of three transmissions). The end of the PSSCH sending means that PSSCH transmission is successful, and no LBT failure indication is received from the physical layer. For example, the sending terminal may start or restart the sidelink configured grant timer associated with the sidelink HARQ process at the first slot/symbol at the end of the PSSCH transmission. For example, the sending terminal may start or restart the sidelink configured grant timer associated with the sidelink HARQ process at the first slot/symbol at the start of the PSSCH transmission.

In an embodiment, the terminal completes sending of the PUCCH, and starts or restarts the sidelink configured grant timer associated with the sidelink HARQ process.

In some examples, if a time Alignment Timer (TAT) associated with a Timing advance group (TAG), where a serving cell, which carries the HARQ feedback and is configured with the PUCCH (i.e., a serving cell where a PUCCH resource transmitting the HARQ feedback is located), is located, does not time out, the terminal needs to send the HARQ feedback on the PUCCH.

In some examples, the sending terminal may start or restart the sidelink configured grant timer associated with the sidelink HARQ process at the first slot/symbol at the end of the PUCCH transmission.

Please refer to FIG. 9. FIG. 9 is a schematic diagram of a structure of a communication device provided by an embodiment of the present disclosure. The communication device 900 shown in FIG. 9 may include a transceiver module 901 and a processing module 902. The transceiver module 901 may include a sending module and/or a receiving module. The sending module is configured to implement a sending function, and the receiving module is configured to implement a receiving function. The transceiver module 902 may implement the sending function and/or the receiving function.

It may be understood that the communication device 900 may be a terminal, or a device in the terminal, or a device capable of being matched with the terminal for use.

The communication device 900 is on a terminal side.

The transceiver module 901 is configured to receive DCI sent by a network device.

The processing module 902 is configured to start or restart a sidelink CGT associated with a sidelink HARQ process according to sidelink transmission scheduled by the DCI.

In some examples, the processing module 902 is configured to:

determine, according to an HARQ process identifier carried by the DCI, a sidelink HARQ process associated with the HARQ process identifier; and start or restart the sidelink CGT associated with the sidelink HARQ process.

In some examples, the processing module 902 is configured to start or restart the sidelink CGT associated with the sidelink HARQ process according to a PSSCH in the sidelink transmission.

In some examples, the processing module 902 is configured to start or restart the sidelink CGT associated with the sidelink HARQ process at the end of each PSSCH transmission in the sidelink transmission.

In some examples, the processing module 902 is configured to start or restart the sidelink CGT associated with the sidelink HARQ process at the end of the last PSSCH transmission in the sidelink transmission.

In some examples, the processing module 902 is configured to determine whether to stop the sidelink CGT associated with the sidelink HARQ process according to HARQ feedback associated with the PSSCH in the sidelink transmission. The sidelink HARQ process is an HARQ process associated with the PSSCH.

In some examples, the processing module 902 is configured to:
stop, in a case where a service type is a multicast service and an HARQ feedback mode is an ACK-NACK, the sidelink CGT associated with the sidelink HARQ process in response to detecting an ACK for an HARQ-enabled data packet on a PSFCH associated with the PSSCH; and
not stop, in the case where the service type is the multicast service and the HARQ feedback mode is the ACK-NACK, the sidelink CGT associated with the sidelink HARQ process in response to detecting an NACK for the HARQ-enabled data packet on the PSFCH associated with the PSSCH.

In some examples, the processing module 902 is configured to stop, in a case where the service type is the multicast service and the HARQ feedback mode is an NACK-only, the sidelink CGT associated with the sidelink HARQ process in response to detecting no HARQ feedback for the HARQ-enabled data packet on the PSFCH associated with the PSSCH.

In some examples, the processing module 902 is configured to:
stop, in a case where the service type is a unicast service, the sidelink CGT associated with the sidelink HARQ process in response to detecting the ACK for the HARQ-enabled data packet on the PSFCH associated with the PSSCH; and
not stop, in the case where the service type is the unicast service, the sidelink CGT associated with the sidelink HARQ process in response to detecting the NACK for the HARQ-enabled data packet on the PSFCH associated with the PSSCH.

In some examples, the processing module 902 is further configured to start or restart the sidelink CGT associated with the sidelink HARQ process at the end of PUCCH transmission for transmitting HARQ feedback associated with the sidelink transmission. The HARQ feedback is an NACK.

In some examples, the transceiver module 901 is further configured to receive the configuration information sent by the network device.

The processing module 902 is further configured to determine the sidelink CGT according to the configuration information.

In some examples, the configuration information includes any one of:
a sidelink CGT corresponding to the terminal;
a sidelink CGT corresponding to a configured sidelink grant configuration;
a sidelink CGT corresponding to a resource pool;
a sidelink CGT corresponding to a BWP; or
a sidelink CGT corresponding to a resource block set.

In some examples, the sidelink CGT is pre-configured.

In the embodiment of the present disclosure, the terminal may receive the DCI sent by the network device, and start or restart the sidelink CGT associated with the sidelink HARQ process according to the sidelink transmission scheduled by the DCI. Thus, the terminal may control starting or restarting of the sidelink CGT associated with the sidelink HARQ process based on the sidelink transmission scheduled by the DCI.

It may be understood that the communication device 900 may be a network device, or a device in the network device, or a device capable of being matched with the network device for use.

The communication device 900 is on a network device side.

The transceiver module 901 is configured to send DCI to the terminal. The DCI is configured to start or restart the sidelink CGT associated with the HARQ process according to sidelink transmission scheduled by the DCI.

In the present disclosure, the network device may send the DCI to the terminal. The DCI is configured to start or restart the sidelink CGT associated with the sidelink HARQ process according to the sidelink transmission scheduled by the DCI. Thus, the terminal may control starting or restarting of the sidelink CGT associated with the sidelink HARQ process based on the sidelink transmission scheduled by the DCI.

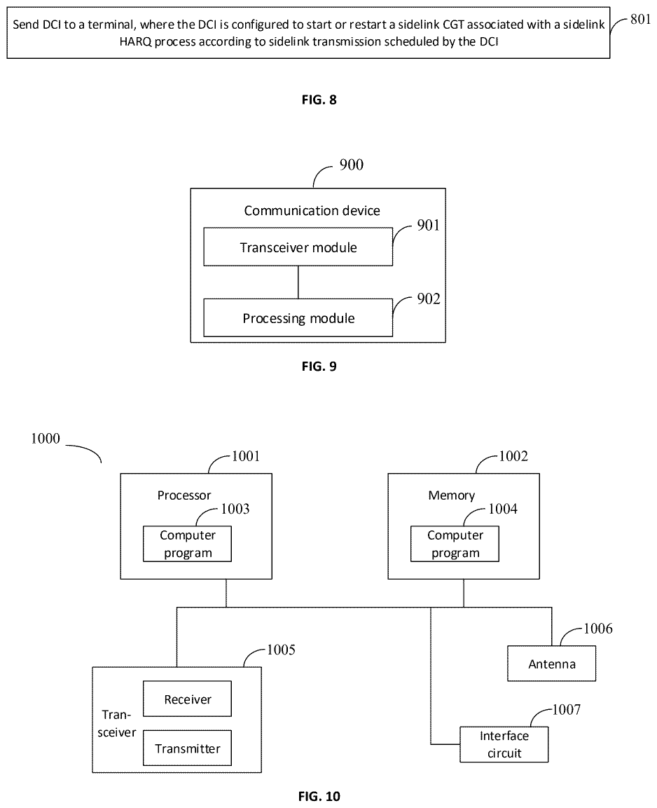

Please refer to FIG. 10. FIG. 10 is a schematic diagram of a structure of a communication device provided by another embodiment of the present disclosure. In FIG. 10, the communication device 1000 may be a network device, may also be a terminal, may also be a chip, a system on chip, or a processor, etc., that supports a network device to implement the above method, and may further be a chip, a system on chip, or a processor, etc., that supports a terminal to implement the above method. The device may be configured to implement the methods described in the above method embodiments, which may refer to the description in the above method embodiments for details.

The communication device 1000 may include one or more processors 1001. The processor 1001 may be a general purpose processor or a specialized processor, etc. The processor may be, for example, a baseband processor or a central processing unit. The baseband processor may be configured to process a communication protocol and communication data, and the central processing unit may be configured to control a communication device (e.g., a base station, a baseband chip, a terminal, a terminal chip, a DU or a CU, etc.), execute a computer program, and process data of the computer program.

In some examples, the communication device 1000 may further include one or more memories 1002 on which a computer program 1004 may be stored, and the processor 1001 executes the computer program 1004 to enable the communication device 1000 to perform the methods described in the method embodiments above. In some examples, data may also be stored in the memory 1002. The communication device 1000 and the memory 1002 may be disposed separately or may be integrated together.

In some examples, the communication device 1000 may further include a transceiver 1005 and an antenna 1006. The transceiver 1005 may be referred to as a transceiver unit, a transceiver machine, or a transceiver circuit, etc., and is configured to implement a receiving and sending function. The transceiver 1005 may include a receiver and a transmitter. The receiver may be referred to as a receiving machine or a receiving circuit, etc., and is configured to implement a receiving function. The transmitter may be referred to as a sending machine or a sending circuit, etc., and is configured to implement a sending function.

In some examples, the communication device 1000 may further include one or more interface circuits 1007. The interface circuit 1007 is configured to receive code instructions and transmit the code instructions to the processor 1001. The processor 1001 runs the code instructions to enable the communication device 1000 to perform the methods described in the above method embodiments.

The communication device 1000 is a terminal. The processor 1001 is configured to perform step 302 in FIG. 3, step 402 and step 403 in FIG. 4, step 502 in FIG. 5, step 602 in FIG. 6, step 702 in FIG. 7, etc.

In an implementation, the processor 1001 may include a transceiver configured to implement a receiving and sending function. For example, the transceiver may be a transceiver circuit, or an interface, or an interface circuit. The transceiver circuit, interface, or interface circuit configured to implement the receiving and sending function may be separate or integrated together. The above transceiver circuit, interface, or interface circuit may be used for reading and writing codes/data, or the above transceiver circuit, interface, or interface circuit may be used for transmitting or passing a signal.

In an implementation, the processor 1001 may store a computer program 1003. The computer program 1003 runs on the processor 1001 and may enable the communication device 1000 to perform the methods described in the method embodiments above. The computer program 1003 may be solidified in the processor 1001, in which case the processor 1001 may be implemented by hardware.

In an implementation, the communication device 1000 may include a circuit, and the circuit may implement the function of sending, receiving, or communicating in the foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and the transceiver may also be fabricated using a variety of IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), and so on.

The communication device in the description of the above embodiments may be a network device or a terminal, but the scope of the communication device described in the present disclosure is not limited to this, and the structure of the communication device may not be limited by FIG. 10. The communication device may be a separate device or may be part of a larger device. For example, the communication device may be:
(1) a separate integrated circuit (IC), or a chip, or, a system on chip or a sub-system;
(2) a set having one or more ICs, in some examples, the set of ICs may also include a storage component for storing data and a computer program;
(3) an ASIC, such as a modem;
(4) a module that may be embedded in other devices;
(5) a receiver, a terminal, an intelligent terminal, a cellular phone, a wireless device, a handset, a mobile unit, an in-vehicle device, a network device, a cloud device, an artificial intelligence device, etc.; or
(6) other, etc.

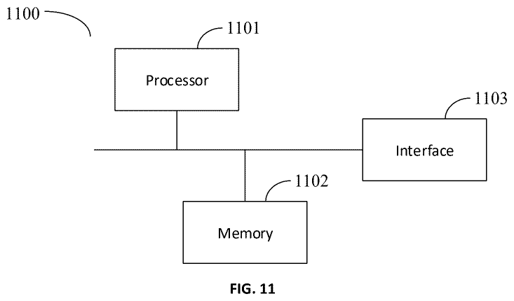

In a case where the communication device may be a chip or a system on chip, reference may be made to a schematic diagram of a structure of a chip shown in FIG. 11. The chip 1100 shown in FIG. 11 includes a processor 1101 and an interface 1103. There may be one or more processors 1101 and a plurality of interfaces 1103.

In a case where the chip is configured to implement the functions of the terminal in the embodiments of the present disclosure:

the interface 1103 is configured to perform step 301 in FIG. 3, step 401 in FIG. 4, step 501 in FIG. 5, step 601 in FIG. 6, step 701 in FIG. 7, etc.

In a case where the chip is configured to implement the functions of the network device in the embodiments of the present disclosure:
the interface 1103 is configured to perform step 801 in FIG. 8.

In some examples, the chip 1100 further includes a memory 1102, and the memory 1102 is configured to store necessary computer programs and data.

Those skilled in the art may further know that various illustrative logical blocks and steps listed in the embodiments of the present disclosure may be implemented by electronic hardware, computer software, or a combination thereof. Whether such a function is implemented by hardware or software depends on a specific application and design requirements of the overall system. Those skilled in the art may use, for each specific application, various methods to implement the described function, but such implementation is not to be construed as exceeding the scope of protection of the embodiments of the present disclosure.

The present disclosure further provides a readable storage medium having stored instructions thereon. The instructions, when executed by a computer, implement the function of any one of the above method embodiments.

The present disclosure further provides a computer program product. The computer program product, when executed by a computer, implements the function of any one of the above method embodiments.

In the above embodiments, the functions may be implemented in whole or in part by software, hardware, firmware, or any combination thereof. When implemented by using software, the functions may be implemented in whole or in part in the form of a computer program product. The computer program product includes one or more computer programs. When the computer program is loaded and executed on a computer, the processes or functions described according to the embodiments of the present disclosure are generated in whole or in part. The computer may be a general-purpose computer, a specialized computer, a computer network, or other programmable devices. The computer program may be stored in a computer-readable storage medium or transmitted from one computer-readable storage medium to another computer-readable storage medium. For example, the computer program may be transmitted from one website, computer, server, or data center to another website, computer, server, or data center in a wired (e.g., a coaxial cable, an optical fiber, and a digital subscriber line (DSL)) or wireless (e.g., infrared, wireless, microwave, etc.) manner. The computer-readable storage medium may be any available medium accessible by a computer, or a data storage device such as a server or a data center that includes one or more integrated available media. The available medium may be a magnetic medium (e.g., a floppy disk, a hard disk, and a tape), an optical medium (e.g., a high-density digital video disc (DVD)), or a semiconductor medium (e.g., a solid state disk (SSD)), etc.

Those ordinarily skilled in the art may understand that “first,” “second,” and various other numerical numbers involved in the present disclosure are merely distinguished for descriptive convenience, are not used for limiting the scope of the embodiments of the present disclosure, and also indicate a sequential order.

“At least one” in the present disclosure may also be described as one or more, and “a plurality of” may indicate two, three, four, or more, which is not limited in the present disclosure. In the embodiments of the present disclosure, for a kind of technical features, technical features in the kind of technical features are distinguished with “first,” “second,” “third,” “A,” “B,” “C,” “D,” etc. There is no sequential order or size order among the technical features described with “first,” “second,” “third,” “A,” “B,” “C,” and “D.”

Correspondences shown in the tables in the present disclosure may be configured or may be pre-defined. Values of information in the tables are merely examples and may be configured as other values, which is not limited by the present disclosure. When a correspondence between information and each parameter is configured, it is not necessarily required that all correspondences illustrated in each table must be configured. For example, the correspondence illustrated in certain rows of the tables in the present disclosure may also not be configured. In another example, appropriate transformation adjustments, such as splitting and merging, may be made based on the above tables. Names of parameters shown in headings in the above tables may also be other names understandable by the communication device, and values or representations of the parameters of which may also be other values or representations understandable by the communication device. Each of the above tables may also be implemented with other data structures, such as an array, a queue, a container, a stack, a linear table, a pointer, a chained table, a tree, a graph, a structure, a class, a heap, a hashing table, or a hash table.

1. A method for starting or restarting a sidelink (SL) configured grant timer (CGT), comprising:
receiving downlink control information (DCI) sent by a network device; and
starting or restarting a sidelink CGT associated with a sidelink hybrid automatic repeat request (HARQ) process according to a sidelink transmission scheduled by the DCI.

2. The method according to claim 1, wherein starting or restarting the sidelink CGT associated with the sidelink HARQ process according to the sidelink transmission scheduled by the DCI comprises:
determining, according to an HARQ process identifier carried by the DCI, a sidelink HARQ process associated with the HARQ process identifier; and
starting or restarting the sidelink CGT associated with the sidelink HARQ process.

3. The method according to claim 1, wherein starting or restarting the sidelink CGT associated with the sidelink HARQ process according to the sidelink transmission scheduled by the DCI comprises:
starting or restarting the sidelink CGT associated with the sidelink HARQ process according to a physical sidelink shared channel (PSSCH) in the sidelink transmission.

4. The method according to claim 3, wherein starting or restarting the sidelink CGT associated with the sidelink HARQ process according to the PSSCH in the sidelink transmission comprises:
starting or restarting the sidelink CGT associated with the sidelink HARQ process at an end of each PSSCH transmission in the sidelink transmission.

5. The method according to claim 3, wherein starting or restarting the sidelink CGT associated with the sidelink HARQ process according to the PSSCH in the sidelink transmission comprises:
starting or restarting the sidelink CGT associated with the sidelink HARQ process at an end of the last PSSCH transmission in the sidelink transmission.

6. The method according to claim 1, wherein starting or restarting the sidelink CGT associated with the sidelink HARQ process according to the sidelink transmission scheduled by the DCI comprises:
determining whether to stop the sidelink CGT associated with the sidelink HARQ process according to HARQ feedback associated with a physical sidelink shared channel (PSSCH) in the sidelink transmission, wherein the sidelink HARQ process is an HARQ process associated with the PSSCH.

7. The method according to claim 6, wherein determining whether to stop the sidelink CGT associated with the sidelink HARQ process according to the HARQ feedback associated with the PSSCH in the sidelink transmission comprises:
stopping, in a case where a service type is a multicast service and an HARQ feedback mode is a positive-negative acknowledgement (ACK-NACK), the sidelink CGT associated with the sidelink HARQ process in response to detecting an ACK for an HARQ-enabled data packet on a physical sidelink feedback channel (PSFCH) associated with the PSSCH;
not stopping, in the case where the service type is the multicast service and the HARQ feedback mode is the ACK-NACK, the sidelink CGT associated with the sidelink HARQ process in response to detecting an NACK for the HARQ-enabled data packet on the PSFCH associated with the PSSCH; and
stopping, in a case where the service type is the multicast service and the HARQ feedback mode is a negative-only acknowledgement (NACK-only), the sidelink CGT associated with the sidelink HARQ process in response to detecting no HARQ feedback for the HARQ-enabled data packet on the PSFCH associated with the PSSCH.

8. The method according to claim 6, wherein determining whether to stop the sidelink CGT associated with the sidelink HARQ process according to the HARQ feedback associated with the PSSCH in the sidelink transmission comprises:
stopping, in a case where a service type is a unicast service, the sidelink CGT associated with the sidelink HARQ process in response to detecting a positive acknowledgement (ACK) for an HARQ-enabled data packet on a physical sidelink feedback channel (PSFCH) associated with the PSSCH; and
not stopping, in the case where the service type is the unicast service, the sidelink CGT associated with the sidelink HARQ process in response to detecting a negative acknowledgement (NACK) for the HARQ-enabled data packet on the PSFCH associated with the PSSCH.

9. The method according to claim 1, further comprising:
starting or restarting the sidelink CGT associated with the sidelink HARQ process at an end of physical uplink control channel (PUCCH) transmission for transmitting HARQ feedback associated with the sidelink transmission, wherein the HARQ feedback is a negative acknowledgement (NACK).

10. The method according to claim 1, further comprising:
receiving configuration information sent by the network device; and
determining the sidelink CGT according to the configuration information.

11. The method according to claim 10, wherein the configuration information comprises any one of:
a sidelink CGT corresponding to a terminal;
a sidelink CGT corresponding to a configured sidelink grant configuration;
a sidelink CGT corresponding to a resource pool;
a sidelink CGT corresponding to a bandwidth part (BWP); or
a sidelink CGT corresponding to a resource block set.

12. The method according to claim 1, wherein the sidelink CGT is pre-configured.

13. A method for starting or restarting a sidelink (SL) configured grant timer (CGT), comprising:
sending downlink control information (DCI) to a terminal, wherein the DCI is configured to start or restart a sidelink CGT associated with a sidelink hybrid automatic repeat request (HARQ) process according to a sidelink transmission scheduled by the DCI.

14. (canceled)

15. (canceled)

16. A communication device, comprising a processor and a memory, wherein a computer program is stored in the memory, and the processor executes the computer program stored in the memory to enable the device to:
receive downlink control information (DCI) sent by a network device; and
start or restart a sidelink configured grant timer (CGT) associated with a sidelink hybrid automatic repeat request (HARQ) process according to a sidelink transmission scheduled by the DCI.

17. A non-transitory computer-readable storage medium, configured to store instructions, wherein the instructions, when executed, cause the method according to claim 1 to be implemented.

18. The communication device according to claim 16, wherein the processor further enables the device, in response to starting or restarting the sidelink CGT associated with the sidelink HARQ process according to the sidelink transmission scheduled by the DCI, to:
determine, according to an HARQ process identifier carried by the DCI, a sidelink HARQ process associated with the HARQ process identifier; and
start or restart the sidelink CGT associated with the sidelink HARQ process.

19. The communication device according to claim 16, wherein the processor further enables the device, in response to starting or restarting the sidelink CGT associated with the sidelink HARQ process according to the sidelink transmission scheduled by the DCI, to:
start or restart the sidelink CGT associated with the sidelink HARQ process according to a physical sidelink shared channel (PSSCH) in the sidelink transmission.

20. The communication device according to claim 16, wherein the processor further enables the device, in response to starting or restarting the sidelink CGT associated with the sidelink HARQ process according to the sidelink transmission scheduled by the DCI, to:
determine whether to stop the sidelink CGT associated with the sidelink HARQ process according to HARQ feedback associated with a physical sidelink shared channel (PSSCH) in the sidelink transmission, wherein the sidelink HARQ process is an HARQ process associated with the PSSCH.

21. A communication device, comprising a processor and a memory, wherein a computer program is stored in the memory, and the processor executes the computer program stored in the memory to enable the device to perform the method according to claim 13.

22. A non-transitory computer-readable storage medium, configured to store instructions, wherein the instructions, when executed, cause the method according to claim 13 to be implemented.
